(19) United States
(12) Patent Application Publication
(10) Pub. No.: US 2014/0055634 A1
(43) Pub. Date: Feb. 27, 2014

(54) IMAGE PROCESSING DEVICE AND METHOD, PROGRAM, AND SOLID-STATE IMAGING DEVICE

(71) Applicant: SONY CORPORATION, Minato-ku (JP)

(72) Inventors: Yuki TOKIZAKI, Tokyo (JP); Keisuke Chida, Tokyo (JP)

(21) Appl. No.: 13/933,496

(22) Filed: Jul. 2, 2013

(30) Foreign Application Priority Data
Aug. 23, 2012 (JP) 2012-183838

(51) Int. Cl. G06T 9/00; H04N 5/232

(52) U.S. Cl. CPC G06T 9/004; H04N 5/23229
USPC 348/222.1; 382/166

(57) ABSTRACT

There is provided an image processing device including a prediction tap acquisition unit that acquires, as prediction taps, values of a plurality of pixels decided according to a pixel of interest from a plurality of input images which are formed by pixels each having a single color component and have different array forms of the pixels, a coefficient data storage unit that stores data of coefficients multiplied by the respective acquired prediction taps, and a prediction calculation unit that computes, through calculation using the prediction taps and the coefficients, a value of the pixel of interest in an output image formed by pixels having a plurality of color components, which is an image obtained by demosaicing the input images.

### BACKGROUND

The present disclosure relates to an image processing device and method, a program, and a solid-state imaging device, and particularly to an image processing device and method, a program, and a solid-state imaging device that can realize a demosaicing process according to a plurality of array forms at a low cost while suppressing a circuit scale.

An imaging device that has only one imaging element for the purpose of miniaturizing the size thereof generally has different color filters for each pixel of the imaging element, and captures an image having a color component (for example, any one of three color components of an R component, a G component, and a B component) which expresses any one of a plurality of color components for each pixel. Since such an image having a color component which expresses any one of the plurality of color components for each pixel generally includes pixels arranged in a form that is called a Bayer array, the image is called a Bayer array image.

In addition, a color image having the plurality of color components for each pixel (for example, an image having three color components of the R component, the G component, and the B component) is generally generated based on the Bayer array image using an interpolation process, or the like. Such a color image having the plurality of color components for each pixel is called an RGB image. For example, a process of obtaining an RGB image by performing the interpolation process on the Bayer array image is called demosaicing.

Such a Bayer array image enables various color arrays with arrays of color filters. Generally, a Bayer array image is formed by disposing rows in which R pixels and G pixels are repeatedly arranged and rows in which G pixels and B pixels are repeatedly arranged in an alternate manner using pixels disposed in a two-dimensional matrix shape.

Meanwhile, pixel density is also heightened in a general Bayer array image. For example, a Bayer array image obtained by quadrupling the pixel density of the general Bayer array image is also used.

When a Bayer array image is demosaiced to be an RGB image, a process for reducing noise, and a process for improving an acute feeling can also be executed in order to enhance quality of an output image.

For example, a technique in which first characteristic information is generated by extracting a plurality of pixels in the vicinity of a pixel of interest for each pixel of interest of an input image signal and performing an ADRC process on signal values of the plurality of pixels, signal values of pixels in acute edge portions of the input image signal are extracted as second characteristic information, one class is decided based on the first and second characteristic information, and a pixel having at least a color component different from a color component that the pixel of interest has is generated based on the decided class has also been developed (for example, refer to Japanese Unexamined Patent Application Publication No. 2002-64835).

### SUMMARY

However, when demosaicing is performed using the technique disclosed in Japanese Unexamined Patent Application Publication No. 2002-64835, for example, it is necessary to store a plurality of pieces of coefficient data according to the number of array form types of a Bayer array image such as a Bayer array image with a plurality of pixel densities.

In addition, since a class tap or a prediction tap is changed according to array forms, it is necessary to prepare a plurality of conversion processes.

In other words, in a technique of the related art, coefficient data generated in advance from learning and a conversion processing unit should be prepared for each array form of an input image, which leads to an increase in a circuit scale, an increase in memory capacity, and a cost rise.

It is desirable to be able to realize a demosaicing process performed according to a plurality of array forms at low cost while suppressing a circuit scale.

According to a first embodiment of the present technology, there is provided an image processing device including a prediction tap acquisition unit that acquires, as prediction taps, values of a plurality of pixels decided according to a pixel of interest from a plurality of input images which are formed by pixels each having a single color component and have different array forms of the pixels, a coefficient data storage unit that stores data of coefficients multiplied by the respective acquired prediction taps, and a prediction calculation unit that computes, through calculation using the prediction taps and the coefficients, a value of the pixel of interest in an output image formed by pixels having a plurality of color components, which is an image obtained by demosaicing the input images. The prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.

Each of the input images may be a Bayer array image formed by pixels each having a single color component of each color of red, green, and blue, or a Bayer 2×2 array image obtained by dividing each pixel of the Bayer array image into pixels having a same color in two rows and two columns, and the output image may be an RGB image formed by pixels having three color components of red, green, and blue.

When the input image is the Bayer 2×2 array image, the prediction tap acquisition unit may acquire a same prediction tap corresponding to pixels of interest at four adjacent positions.

When the input image is the Bayer array image, the prediction calculation unit may compute an average value or a representative value of the coefficients multiplied by four taps in prediction taps of the Bayer 2×2 array image, and compute the value of the pixel of interest in the output image by multiplying the computed average value or representative value by prediction taps of the Bayer array image.

The image processing device may further include a class tap acquisition unit that acquires values of a plurality of pixels decided according to the pixel of interest from the input images as class taps, and a class classification unit that classifies the pixel of interest into a predetermined class.

When the input image is the Bayer 2×2 array image, the class tap acquisition unit may acquire class taps obtained by dividing each pixel constituting class taps of the Bayer array image into pixels having a same color in two rows and two columns.

When the input image is the Bayer 2×2 array image, the class classification unit may compute an average value or a representative value of four pixels having a same color constituting the class taps, decide class codes having a same number of digits as a class code when the input image is the Bayer array image by performing an ADRC process on the computed average value or representative value, and perform class-classification on the pixel of interest.

When the input image is the Bayer array image, the class classification unit may decide a class code having a same number of digits as class codes when the input image is the Bayer 2×2 array image by interpolating some quantization codes obtained by performing an ADRC process on values of pixels constituting the class taps, and perform class-classification on the pixel of interest.

Data of coefficients stored in the coefficient data storage unit may be set to be data of coefficients computed by learning with an RGB image having same pixel density as the Bayer 2×2 array image as a teaching image and a Bayer 2×2 array image generated by thinning color components of each pixel of the RGB image as a studying image.

The image processing device may further include an input image conversion unit that converts an image in a predetermined array form into an image in another array form according to an operation mode and supplies the image as an input image.

According to the first embodiment of the present technology, there is provided an image processing method including acquiring, as prediction taps, values of a plurality of pixels decided according to a pixel of interest from a plurality of input images which are formed by pixels each having a single color component and have different array forms of the pixels by a prediction tap acquisition unit, and computing a value of the pixel of interest in an output image formed by pixels having a plurality of color components, which is an image obtained by demosaicing the input images through calculation using the prediction taps and coefficients stored in a coefficient data storage unit. Using coefficients multiplied by respective prediction taps acquired from a first input image with predetermined pixel density, the value of the pixel of interest in an output image obtained by demosaicing a second input image in a different array form of the pixels with lower pixel density lower than the first input image is computed.

According to the first embodiment of the present technology, there is provided a program that instructs a computer to function as an image processing device including a prediction tap acquisition unit that acquires, as prediction taps, values of a plurality of pixels decided according to a pixel of interest from a plurality of input images which are formed by pixels each having a single color component and have different array forms of the pixels, a coefficient data storage unit that stores data of coefficients multiplied by the respective acquired prediction taps, and a prediction calculation unit that computes, through calculation using the prediction taps and the coefficients, a value of the pixel of interest in an output image formed by pixels having a plurality of color components, which is an image obtained by demosaicing the input images. The prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.

According to a second embodiment of the present technology, there is provided a solid-state imaging device including a pixel array having a plane over which a plurality of photoelectric conversion elements are arranged, a prediction tap acquisition unit that acquires, as prediction taps, values of a plurality of pixels decided according to a pixel of interest from a plurality of input images which are generated based on a signal output from the pixel array, are formed by pixels each having a single color component, and have different array forms of the pixels, a coefficient data storage unit that stores data of coefficients multiplied by the respective acquired prediction taps, and a prediction calculation unit that computes, through calculation using the prediction taps and the coefficients, a value of the pixel of interest in an output image formed by pixels having a plurality of color components, which is an image obtained by demosaicing the input images. The prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.

According to the first and the second embodiments of the present disclosure, the values of a plurality of pixels decided according to a pixel of interest are acquired, as prediction taps from a plurality of input images which are formed by pixels each having a single color component and have different array forms of the pixels, data of coefficients multiplied by each of the acquired prediction taps is stored, the value of the pixel of interest in an output image formed by pixels having a plurality of color components, which is an image obtained by demosaicing the input images, is computed through calculation using the prediction taps and the coefficients, and the value of the pixel of interest in an output image obtained by demosaicing a second input image in a different array form of the pixels with pixel density lower than that of a first input image is computed using coefficients multiplied by respective prediction taps acquired from the first input image with predetermined pixel density.

According to an embodiment of the present disclosure described above, a demosaicing process performed according to a plurality of array forms can be realized at a low cost while a circuit scale is suppressed.

### BRIEF DESCRIPTION OF THE DRAWINGS

FIG. 1 is a diagram showing an example of a Bayer array;

FIG. 2 is a diagram showing an example of a Bayer array obtained by quadrupling pixel density of a general Bayer array;

FIG. 3 is a diagram showing an example of a Bayer 2×2 array;

FIG. 4 is a block diagram showing a configuration example of an image quality improvement system using a technique of the related art;

FIG. 5 is a block diagram showing a configuration example of an image quality improvement system to which the present technology is applied;

FIG. 6 is a block diagram showing a configuration example of a prediction signal processing unit of FIG. 5;

FIG. 7 is a diagram showing an example of class taps acquired in a Bayer array image;

FIG. 8 is a diagram showing an example of class taps acquired in a Bayer 2×2 array image;

FIG. 9 is a diagram showing an example of class taps acquired in the Bayer 2×2 array image;

FIG. 10 is a diagram for describing an example of substitution of a class code;

FIG. 11 is a diagram showing an example of prediction taps acquired in the Bayer array image;

FIG. 12 is a diagram showing an example of prediction taps acquired in the Bayer 2×2 array image;

FIG. 13 is a diagram for describing coefficients multiplied by the prediction taps of the Bayer 2×2 array image;

FIG. 14 is a diagram for describing coefficients multiplied by prediction taps of the Bayer array image;

FIGS. 15A to 15C are diagrams showing other examples of acquired prediction taps in the Bayer 2×2 array image;

FIG. 16 is a block diagram showing a configuration example of a learning device to which the present technology is applied;

FIG. 17 is a flowchart describing an example of a learning process;

FIG. 18 is a flowchart describing an example of an image quality improvement demosaicing process;

FIG. 19 is a flowchart describing an example of a class classification adaptation process for each array form;

FIG. 20 is a block diagram showing another configuration example of the image quality improvement system to which the present technology is applied; and

FIG. 21 is a block diagram showing a configuration example of a personal computer.

### DETAILED DESCRIPTION OF THE EMBODIMENT(S)

Hereinafter, preferred embodiments of the present disclosure will be described in detail with reference to the appended drawings.

An imaging device that has only one imaging element generally has different color filters for each pixel of the imaging element, and captures an image having a color component (for example, any one of three color components of an R component, a G component, and a B component) which expresses any one of a plurality of color components for each pixel. In this manner, an image having a color component which expresses any one of the plurality of color components for each pixel generally includes pixels arranged in a form which is called a Bayer array.

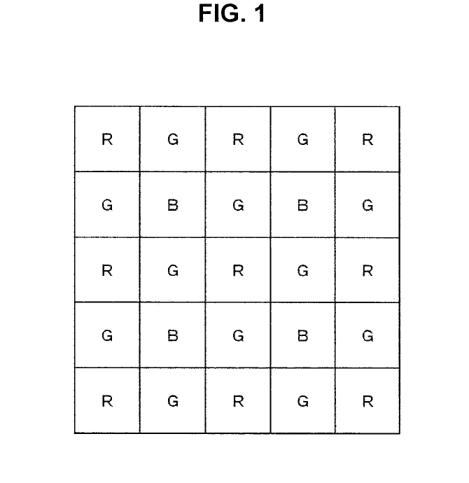

FIG. 1 is a diagram showing an example of a Bayer array. “R” in the drawing indicates a pixel in which a color filter corresponding to red is provided, “G” indicates a pixel in which a color filter corresponding to green is provided, and “B” indicates a pixel in which a color filter corresponding to blue is provided. In the example shown in FIG. 1, with the pixels disposed in a two-dimensional matrix shape, rows in which R pixels and G pixels are repeatedly arranged (for example, first, third, and fifth rows from the top) and rows in which G pixels and B pixels are repeatedly arranged (for example, second and fourth rows from the top) are disposed in an alternate manner.

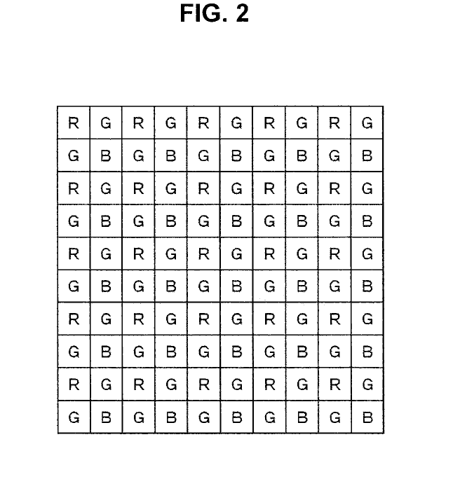

Pixel density of a general Bayer array can be increased. For example, a Bayer array obtained by quadrupling the pixel density of the general Bayer array is also used. FIG. 2 is a diagram showing an example of the Bayer array obtained by quadrupling the pixel density of the general Bayer array.

In the example of FIG. 2, one pixel of FIG. 1 is divided into two rows and two columns, and thereby four pixels are disposed. In other words, each R pixel of FIG. 1 is formed by four pixels of R, G, G, and B pixels in FIG. 2. In the same manner, each G pixel and B pixel of FIG. 1 is formed by of four pixels of R, G, and B pixels.

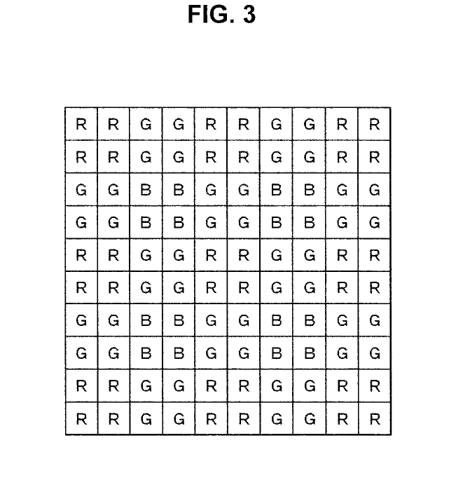

In addition, in recent years, a Bayer array obtained by quadrupling pixel density of a general Bayer array in another way has also been used. FIG. 3 is a diagram showing another example of a Bayer array obtained by quadrupling pixel density of a general Bayer array.

In the example of FIG. 3, each pixel of FIG. 1 is divided into two rows and two columns, and thereby four pixels having the same color are disposed. In other words, each R pixel of FIG. 1 is formed by four pixels of R, R, R, and R pixels in FIG. 2. In the same manner, each G pixel and each B pixel of FIG. 1 is formed by four pixels of G, G, G, and G pixels and four pixels of B, B, B, and B pixels.

When the Bayer array is formed as shown in FIG. 2, for example, it is necessary to appropriately dispose color filters corresponding to three colors of R, G, and B in an extremely small area. Thus, in the case shown in FIG. 2, a high technical capability is necessary for preventing color leakage, or the like. With regard to this manner, when the Bayer array is formed as shown in FIG. 3, for example, such a problem of color leakage or the like can be minimized at a lower cost than in the case of FIG. 2. In addition, when the Bayer array is formed as shown in FIG. 3, for example, the number of pixels constituting an image increases more than in the case shown in FIG. 1, and therefore a high-definition image can be obtained.

Herein, the array form shown in FIG. 3 is called a Bayer 2×2 array.

An image obtained using pixels corresponding to such array forms as shown in FIGS. 1 to 3 becomes an image in which each pixel has only one color component of R, G or B. In order to come close to an image observed by the eyes of a human, it is necessary to convert an image in which each pixel has only one color component of R, G, or B into an image in which each pixel has three color components of R, G, and B. In this manner, converting an image formed by pixels each having a single color component into an image formed by pixels each having a large number of color components is called demosaicing.

Herein, the image captured using pixels corresponding to the array form shown in FIG. 1 is called a Bayer array image, and the image captured using pixels corresponding to the array form shown in FIG. 3 is called a Bayer 2×2 array image. In addition, an image in which each pixel has three color components of R, G, and B is called an RGB image.

When a Bayer array image or a Bayer 2×2 array image is demosaiced to be an RGB image, a process for reducing noise and a process for improving an acute feeling can also be performed to enhance the quality of the output image. For example, class classification is performed using information on pixels in the periphery of a pixel of interest in the Bayer array image, and based on the class classification result, a color component other than the above-described color component can be generated on the pixel of interest using data learned beforehand.

However, if the Bayer array image is demosaiced to be an RGB image in the related art, it is necessary to prepare coefficient data and a signal processing method different from those when the Bayer 2×2 array image is demosaiced to be an RGB image.

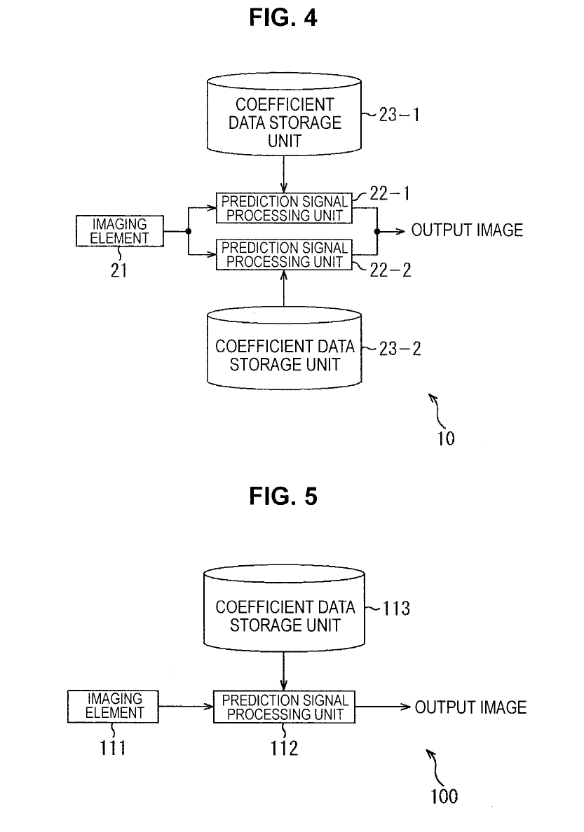

FIG. 4 is a block diagram showing a configuration example of an image quality improvement system using a technique of the related art. The image quality improvement system 10 shown in the drawing demosaics the Bayer array image to be an RGB image, or demosaics the Bayer 2×2 array image be an RGB image. In addition, the image quality improvement system 10 performs a process for reducing noise and a process for improving an acute feeling during demosaicing in order to enhance the quality of the output image.

The image quality improvement system 10 of FIG. 4 includes an imaging element 21, a prediction signal processing unit 22-1, another prediction signal processing unit 22-2, a coefficient data storage unit 23-1, and another coefficient data storage unit 23-2.

The imaging element 21 captures and outputs images. The imaging element 21 can output, for example, both the Bayer array image and the Bayer 2×2 array image.

The prediction signal processing unit 22-1 demosaics, for example, the Bayer array image output from the imaging element 21. The prediction signal processing unit 22-2 demosaics, for example, the Bayer 2×2 array image output from the imaging element 21. In addition, the prediction signal processing unit 22-1 and the prediction signal processing unit 22-2 respectively perform the process for reducing noise and the process for improving the acute feeling in order to improve the quality of the output images during the demosaicing.

The prediction signal processing unit 22-1 and the prediction signal processing unit 22-2 specify pixels of interest which are the pixels to be demosaiced in the Bayer array image and the Bayer 2×2 array image which are input images.

Then, the prediction signal processing unit 22-1 and the prediction signal processing unit 22-2 respectively extract class taps formed by a plurality of pixels having the pixels of interest as the centers, and then perform class classification based on pixel values constituting the class taps. As a method for performing the class classification, for example, ADRC (Adaptive Dynamic Range Coding), or the like can be employed, and the classes of the pixels of interest are specified using codes of ADRC as class codes.

The prediction signal processing unit 22-1 and the prediction signal processing unit 22-2 extract prediction taps formed by a plurality of pixels having the pixels of interest of the input images as the centers, perform a product-sum operation by multiplying coefficients decided according to the classes of the pixels of interest by the value of each pixel constituting the prediction taps, and thereby compute prediction values of the pixels of interest. At this moment, the prediction signal processing unit 22-1 reads a coefficient stored in the coefficient data storage unit 23-1, and then multiplies the coefficient by the value of each pixel of the prediction tap. On the other hand, the prediction signal processing unit 22-2 reads a coefficient stored in the coefficient data storage unit 23-2, and then multiplies the coefficient by the value of each pixel of the prediction tap.

Through the product-sum operation performed by the prediction signal processing unit 22-1 and the prediction signal processing unit 22-2, the values (prediction values) of the pixels of interest of the respective RGB images which are the output images are computed. Accordingly, the RGB image with the same pixel density as the Bayer array image is generated and output by the prediction signal processing unit 22-1, and the other RGB image with the same pixel density as the Bayer 2×2 array image is generated and output by the prediction signal processing unit 22-2.

As described above, it is necessary in the related art to provide different prediction signal processing units and coefficient data storage units according to input images in order to improve the quality of the images through demosaicing of the Bayer array image and the Bayer 2×2 array image. In other words, it is not possible in the related art to perform a prediction operation on the Bayer array image and the Bayer 2×2 array image in the different array forms (and pixel densities) using the same coefficient.

However, if different prediction signal processing units and coefficient data storage units according to input images are provided as in the related art, a circuit scale increases, which leads to an increase in memory capacity and a cost rise. In recent years, as miniaturization of devices and cost reduction have proceeded, miniaturization and cost reduction have been demanded for image quality improvement systems.

Thus, the present technology has come to achieve image quality improvement by demosaicing a Bayer array image and a Bayer 2×2 array image using a shared prediction signal processing unit and coefficient data storage unit.

FIG. 5 is a block diagram showing a configuration example of an image quality improvement system to which the present technology is applied. The image quality improvement system 100 shown in the drawing includes an imaging element 111, a prediction signal processing unit 112, and a coefficient data storage unit 113,

The imaging element 111 captures and outputs images. The imaging element 111 outputs, for example, a Bayer 2×2 array image.

The prediction signal processing unit 112 demosaics, for example, the Bayer 2×2 array image output from the imaging element 111.

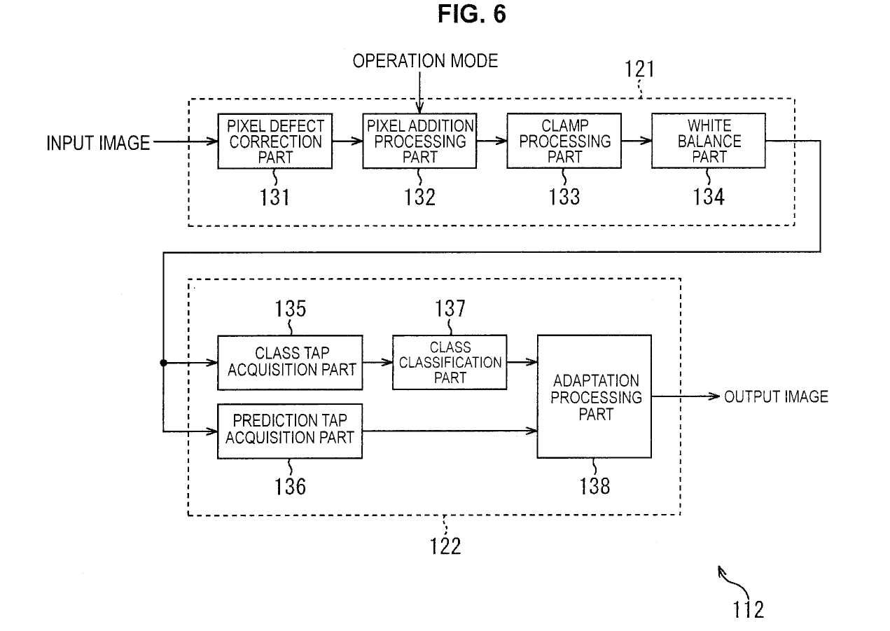

FIG. 6 is a block diagram showing a detailed configuration example of the prediction signal processing unit 112. As shown in the drawing, the prediction signal processing unit 112 is provided with a pre-processing unit 121 and a post-processing unit 122.

The pre-processing unit 121 includes a pixel defect correction part 131, a pixel addition processing part 132, a clamp processing part 133, and a white balance part 134.

The pixel defect correction part 131 detects, for example, a defective pixel (a pixel that does not react to incident light for any reason, or a pixel that accumulates electric charges at all times) among pixels of the imaging element 111, and corrects an output value of the defective pixel by interpolating peripheral normal pixels into the defective pixel so that the normal pixels are not affected by the defective pixel.

The pixel addition processing part 132 converts data of the Bayer 2×2 array image into data of a Bayer array image according to an operation mode. Here, the operation mode is assumed to be, for example, a moving image mode, or a still image mode, and specified based on an operation of an apparatus in which the image quality improvement system 100 is installed.

When the operation mode is the moving image mode, the image quality improvement system 100 is necessary to generate output images according to a frame rate of a moving image, and thus to perform high-speed processing. For this reason, when the operation mode is the moving image mode, for example, the pixel addition processing part 132 performs conversion to the data of the Bayer array image by switching, for example, four pixel values of each color component of R, G, and B of the Bayer 2×2 array image to one pixel value.

As described above referring to FIG. 3, in the Bayer 2×2 array image, four pixels having the same color are disposed by dividing each pixel of the Bayer array image into two rows and two columns. The pixel addition processing part 132 converts the data of the Bayer 2×2 array image into the data of the Bayer array image by switching four pixel values to one pixel value using, for example, the average value of the four pixel values having the same color, or a representative value selected from the four pixel values based on a predetermined criterion.

On the other hand, when the operation mode is the still image mode, the image quality improvement system 100 is not necessary to perform high-speed processing as in the moving image mode. For this reason, when the operation mode is the still image mode, for example, the image addition processing part 132 outputs the data of the Bayer 2×2 array image as is.

Here, an example of converting an array form according to the operation mode by the pixel addition processing part 132 has been described, but an array form may be converted based on other conditions.

In addition, here, description has been provided on the premise that the Bayer 2×2 array image is output from the imaging element 111 at all times and converted into the Bayer array image according to the operation mode. However, the image quality improvement system 100 may be configured such that an imaging element that outputs the Bayer array image and another imaging element that outputs the Bayer 2×2 array image are provided therein, and an image is output from either of the imaging elements according to the operation mode.

The clamp processing part 133 cancels a shift during AD conversion in the imaging element 111. In other words, when AD conversion is performed in the imaging element 111, since a signal value is shifted in a positive direction and subjected to the AD conversion in order to prevent a negative value from being cut, the clamping is performed so that the value corresponding to the shift is canceled.

The white balance part 134 adjusts white balance by correcting a gain of each color component.

The post-processing unit 122 includes a class tap acquisition part 135, a prediction tap acquisition part 136, a class classification part 137, and an adaptation processing part 138.

The class tap acquisition part 135 specifies a pixel of interest that is a pixel to be demosaiced in the Bayer array image or the Bayer 2×2 array image which is an input image. In addition, the class tap acquisition part 135 extracts (acquires) class taps formed by a plurality of pixels having the pixel of interest at the center.

The class classification part 137 performs class classification based on the pixel values constituting the class taps. As a method for performing class classification, for example, ADRC (Adaptive Dynamic Range Coding), or the like can be employed, and the class of the pixel of interest is specified using a code of ADRC as a class code.

The prediction tap acquisition part 136 extracts (acquires) prediction taps formed by the plurality of pixels having the pixel of interest of the input image at the center.

The adaptation processing part 138 performs a product-sum operation by multiplying a coefficient that is decided according to the class of the pixel of interest by each value of the pixels constituting the prediction taps to compute a prediction value of the pixel of interest. At this moment, the adaptation processing part 138 reads the coefficient stored in the coefficient data storage unit 113, and multiplies the coefficient by each value of the pixels of the prediction taps.

The coefficient data storage unit 113 stores the coefficient that is used in the above-described product-sum operation and obtained from learning beforehand in association with the class. In other words, the same number of coefficients as taps (number of pixels) of a prediction tap are stored as according to the number of classes of the pixel of interest in the coefficient data storage unit 113. It should be noted that a process for obtaining coefficients for each class through learning will be described later.

When a coefficient is indicated by Wᵢ and the value of a pixel constituting a prediction tap is indicated by xᵢ, the prediction value of a pixel of interest y is computed using Expression (1).

$$y = {\sum }_{i = 0}^{n} {W}_{i} \cdot {x}_{i} \qquad ( 1 )$$

It should be noted that n in Expression (1) indicates the number of prediction taps.

Through the product-sum operation of the adaptation processing part 138, the value (prediction value) of the pixel of interest of an RGB image that is an output image is computed. Accordingly, the adaptation processing part 138 generates an RGB image with the same pixel density as the Bayer array image, or an RGB image with the same pixel density as the Bayer 2×2 array image.

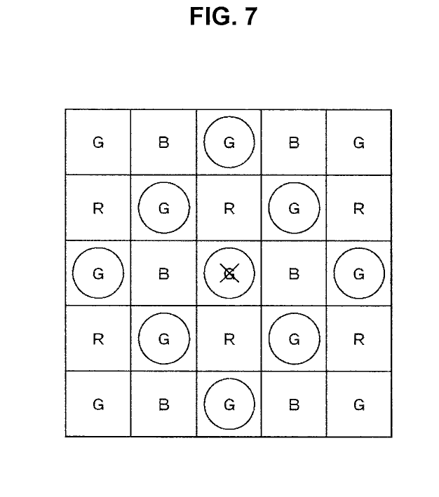

FIG. 7 is a diagram showing an example of class taps acquired by the class tap acquisition part 135 in the Bayer array image. In the example of the drawing, the “G” pixel at the center of the drawing marked with the symbol “x” is set to be a pixel of interest, and nine pixels indicated by circles in the drawing having the pixel of interest at the center are acquired as class taps.

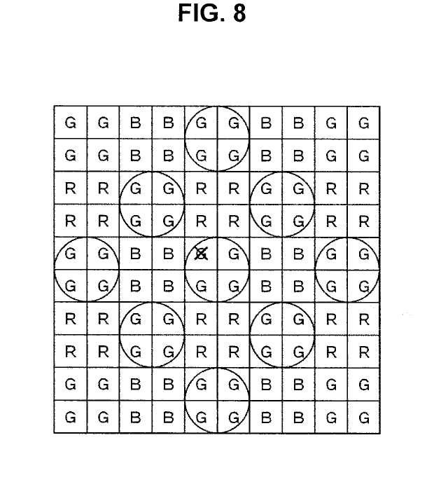

FIG. 8 is a diagram showing an example of class taps acquired by the class tap acquisition part 135 in the Bayer 2×2 array image. In the example of the drawing, the “G” pixel at the center of the drawing marked by the symbol of “x” is set to be a pixel of interest. In FIG. 8, circles are disposed in the same positions as the class taps of FIG. 7, but four pixels are disposed in one circle. In other words, in the Bayer 2×2 array image, pixels in a total of 36 positions, which are the positions of the pixels each constituting a class tap of the Bayer array image divided into four pixels (in two rows and two columns) having the same color, are acquired as class taps.

It should be noted that, if the coordinate of the position of a pixel of interest shown in FIG. 8 is set to be indicated as (n, m), when the coordinate of the position of another pixel of interest is (n+1, m), (n, m+1), or (n+1, m+1), the same class taps as when the coordinate of the position of a pixel of interest is (n, m) are acquired. In other words, when class taps are acquired from the Bayer 2×2 array image in the present technology, the same class taps are acquired corresponding to pixels of interest at four positions adjacent to each other.

When the class classification part 137 performs class classification using ADRC based on the class taps shown in FIG. 7, each quantization code (for example, “1” or “0”) of the values of the pixels constituting the class taps is determined, the quantization codes are arranged in order according to the positions of the pixels, and then 9-digit class codes of the pixels of interest are decided.

When the maximum value and the minimum value of the values of the pixels constituting the class taps are set to be MAX and MIN, a dynamic range is set to be DR (=MAX−MIN+1), and the number of re-quantizing bits is set to be p, a quantization code qi corresponding to a pixel value ki is obtained using Expression (2).

qi=[(ki−MIN+0.5)*2̂p/DR] (2)

In addition, a class code class can be computed using Expression (3) based on the quantization code qi.

$$class = {\sum }_{i = 0}^{n} {{q}_{i} ( {2}^{p} )}^{i - 1} \qquad ( 3 )$$

It should be noted that n in Expression (3) is set to be the number of class taps.

Meanwhile, the class classification part 137 performs class classification using ADRC based on the class taps shown in FIG. 8, and a quantization code is determined by regarding four pixels having the same color surrounded by one circle in FIG. 8 as one tap (pixel). For example, a quantization code is determined based on the average value or a representative value of the four pixels in one circle. Then, a 9-digit class code of a pixel of interest is decided by arranging quantization codes in order according to the positions of the taps.

In this manner, pixels of interest in both of the Bayer array image and in the Bayer 2×2 array image can be classified into classes using the same class code.

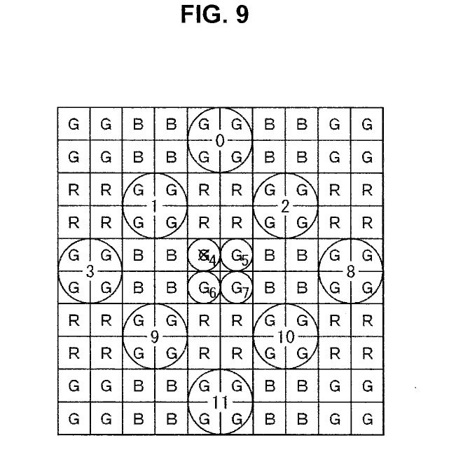

Alternatively, the class taps may be acquired so as to reflect more detailed characteristics of an image thereon. FIG. 9 is a diagram showing another example of class taps acquired by the class tap acquisition part 135 in the Bayer 2×2 array image.

In the example of FIG. 9, tap numbers are given to respective taps surrounded by circles in the drawing. Eight taps of the tap numbers 0 to 3 and 8 to 11 in FIG. 9 are acquired in the same manner as in FIG. 7. However, in FIG. 9, the pixel with the tap number 4 serving as a pixel of interest and three pixels (tap numbers 5 to 7) in the periphery thereof are acquired as one tap, unlike in FIG. 7.

In the example of FIG. 9, since class taps are formed by 12 pixels, a class code of the pixel of interest is 12 digits. In such a case, a class code decided based on class taps acquired from the Bayer array image is substituted with 12 digits in order to share the number of digits of the class code.

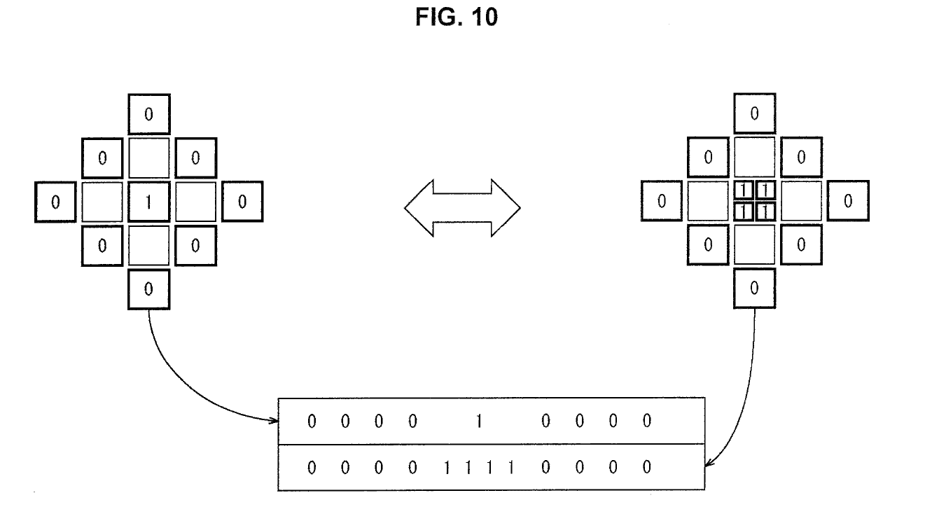

For example, four quantization codes of the tap of the pixel of interest (the tap positioned at the center) in the class taps acquired from the Bayer array image are generated as shown in FIG. 10. When the quantization code of the tap of the pixel of interest among the class taps acquired from the Bayer array image is, for example, “1,” the code is substituted with “1, 1, 1, 1.” In addition, when the quantization code of the tap of the pixel of interest in the class taps acquired from the Bayer array image is, for example, “0,” the code is substituted with “0, 0, 0, 0.” In other words, a class code is decoded by interpolating quantization codes corresponding to the tap of the pixel of interest in the class taps.

In this manner, a class code decided based on the class taps acquired from the Bayer array image is substituted to be 12 digits.

It should be noted that the cases shown in FIGS. 7 to 9 are examples of class taps, and the positions and the number of taps are not limited to those shown in FIGS. 7 and 9.

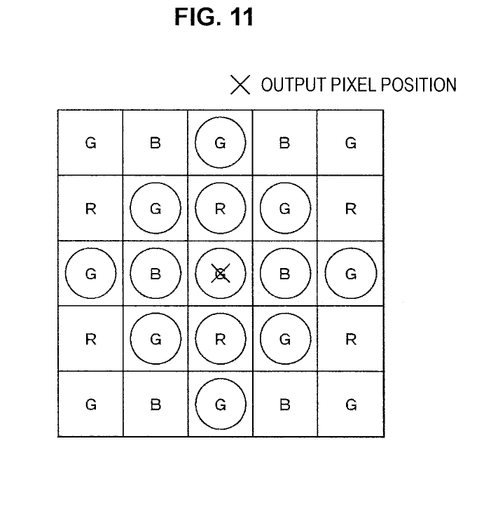

FIG. 11 is a diagram showing an example of prediction taps acquired by the prediction tap acquisition part 136 in the Bayer array image. In the example of the drawing, the “G” pixel at the center of the drawing marked with the symbol “x” is set to be a pixel of interest, and 13 pixels surrounded by circles in the drawing having the pixel of interest at the center are acquired as prediction taps.

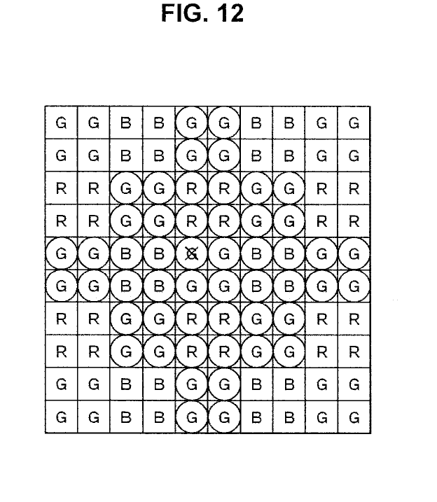

FIG. 12 is a diagram showing an example of prediction taps acquired by the prediction tap acquisition part 136 in the Bayer 2×2 array image. In the example of the drawing, the “G” pixel at the center of the drawing marked with the symbol “x” is set to be a pixel of interest. In FIG. 12, taps are disposed at the same positions as the prediction taps of FIG. 11, but four pixels are disposed in FIG. 12 for one pixel of FIG. 11. In other words, in the Bayer 2×2 array image, pixels in a total of 52 positions, which are the positions of the pixels each constituting a prediction tap of the Bayer array image divided into four pixels (in two rows and two columns) having the same color, are acquired as prediction taps.

It should be noted that the cases shown in FIGS. 11 and 12 are examples of prediction taps, and the positions and the number of taps are not limited to those shown in FIGS. 11 and 12.

In the image quality improvement system 100 to which the present technology is applied, the same number of coefficients as taps (the number of pixels) of the prediction taps in the Bayer 2×2 array image are stored in the coefficient data storage unit 113 beforehand. In other words, in the example of FIG. 12, a coefficient group formed by 52 coefficients is stored for each class code.

On the other hand, since the number of prediction taps in the Bayer array image of FIG. 11 is 13, it is difficult to perform a product-sum operation in that state. Thus, in the present technology, when a product-sum operation is performed based on prediction taps acquired from the Bayer array image, 52 coefficients are converted into 13 coefficients.

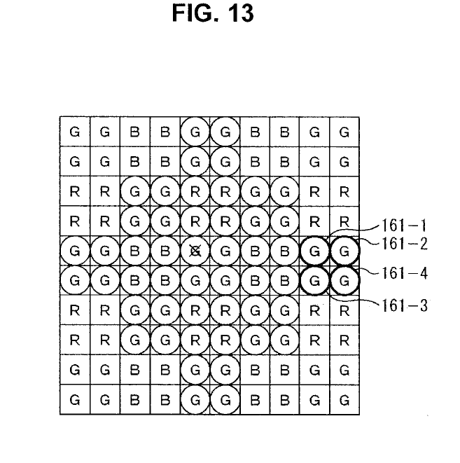

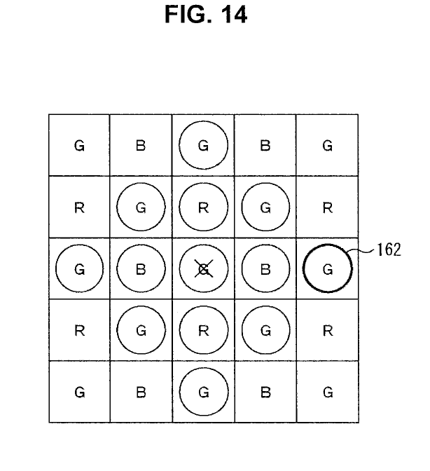

For example, the average value (or a representative value) of four coefficients to be multiplied by four pixels having the same color shown in FIG. 12 is computed, and one obtained average value (or representative value) is multiplied by each tap of FIG. 11. For example, the average value (or a representative value) of four coefficients to be respectively multiplied by four taps of tap 161-1 to 161-4 out of prediction taps of the Bayer 2×2 array image shown in FIG. 13 is computed. One average value (or representative value) obtained in that manner is multiplied by the tap 162 in prediction taps of the Bayer array image shown in FIG. 14.

In this manner, product-sum operations are performed by multiplying 13 taps by 13 coefficients. Thus, in the present technology, by performing product-sum operations using the same coefficients in both of the Bayer array image and the Bayer 2×2 array image, prediction values of pixels of interest can be computed.

As described above, in the present technology, the coefficients are shared in both of the Bayer array image and the Bayer 2×2 array image. In order to enable such sharing, prediction taps are acquired in the following manner in the present technology. In other words, when prediction taps are acquired from the Bayer 2×2 array image, one prediction tap is set to be acquired for four pixels of interest.

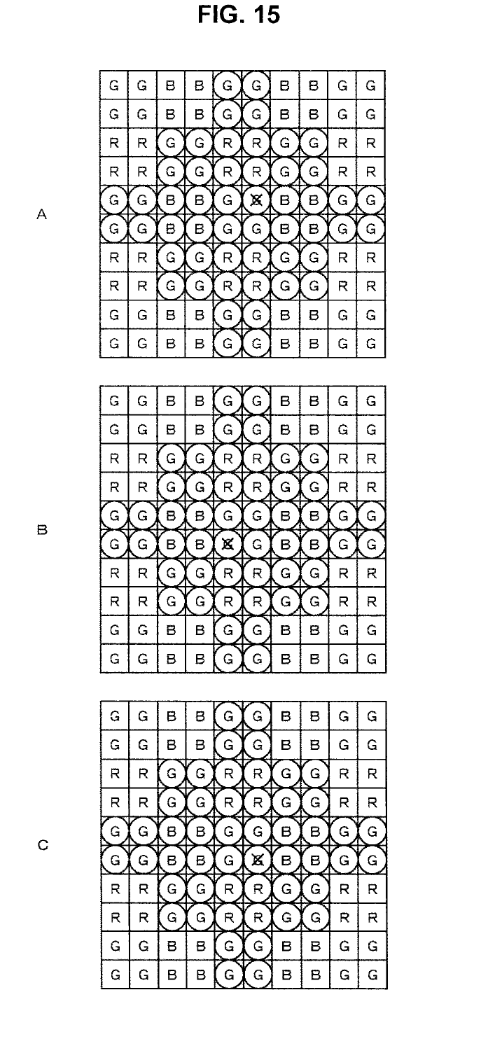

For example, the same prediction tap is acquired for the pixel of interest shown in FIG. 12, and the pixels of interest shown in FIGS. 15A to 15C. FIG. 15A is a diagram in which the position of the pixel of interest is obtained by moving the position thereof in FIG. 12 by one pixel to the right side. FIG. 15B is a diagram in which the position of the pixel of interest is obtained by moving the position thereof in FIG. 12 by one pixel to the lower side. FIG. 15C is a diagram in which the position of the pixel of interest is obtained by moving the position thereof in FIG. 12 by one pixel to the right side and by one pixel to the lower side.

For example, if the coordinate of the position of the pixel of interest shown in FIG. 12 is set to be indicated as (n, m), when the coordinate of the position of another pixel of interest is (n+1, m), (n, m+1), or (n+1, m+1), the same prediction taps as when the coordinate of the position of the pixel of interest is (n, m) are acquired. In other words, when prediction taps are acquired from the Bayer 2×2 array image in the present technology, the same prediction taps are acquired corresponding to the pixels of interest at four positions adjacent to each other.

In this manner, when a pixel of interest in the Bayer 2×2 array image is any one of four pixels having the same color, the same prediction tap is acquired, and thereby a coefficient can be shared in both of the Bayer array image and the Bayer 2×2 array image.

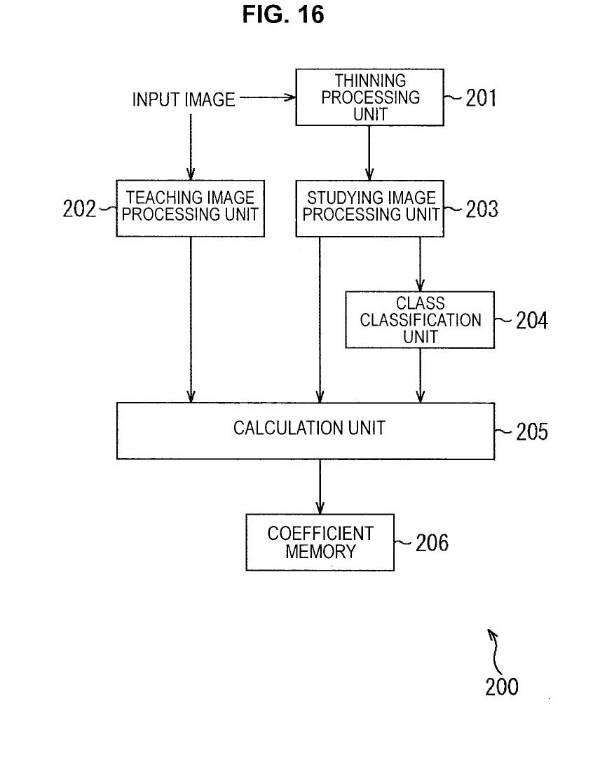

Next, learning of coefficients stored in the coefficient data storage unit 113 will be described. FIG. 16 is a block diagram showing a configuration example of a learning device corresponding to the image quality improvement system 100 shown in FIG. 5. The learning device 200 shown in the drawing computes an optimum coefficient for calculating a prediction value of a pixel of interest in the image quality improvement system 100 based on a teaching image that is an RGB image with high image quality and a studying image that is a Bayer 2×2 array image obtained by degrading the quality of the teaching image.

The learning device 200 shown in FIG. 16 includes a thinning processing unit 201, a teaching image processing unit 202, a studying image processing unit 203, a class classification unit 204, a calculation unit 205, and a coefficient memory 206.

The learning device 200 receives RGB images with high image quality as input images, and supplies the input images as teaching images to the teaching image processing unit 202. It should be noted that pixel density of an input image is set to be the same as that of a Bayer 2×2 array image.

The thinning processing unit 201 degrades the quality of an input image by, for example, inserting noise or the like thereinto, and thins color components of pixels according to the pattern of a color filter array. At this moment, the color components of the pixels are thinned on the assumption of the color filters of the imaging element 111. Accordingly, an RGB image is converted into the Bayer 2×2 array image, and the image obtained after the conversion is supplied to the studying image processing unit 203 as a studying image.

The studying image processing unit 203 acquires class taps and prediction taps from the studying image corresponding to a pixel of interest. The class taps are acquired, for example, as described above referring to FIGS. 7 to 9, and the prediction taps are acquired, for example, as described above referring to FIGS. 11, 12, 15A, 15B, and 15C.

The acquired class taps are supplied to the class classification unit 204, and class codes are decided according to Expressions (2) and (3).

The class codes decided by the class classification unit 204 and the prediction taps acquired by the studying image processing unit 203 are supplied to the calculation unit 205.

The teaching image processing unit 202 acquires a pixel corresponding to the pixel of interest set in the studying image processing unit 203 from the teaching image, and the value of the pixel is supplied to the calculation unit 205 as a prediction value.

It should be noted that the studying image processing unit 203 sets a plurality of pixels constituting the studying image as pixels of interest in order, and class codes, prediction taps, and prediction values for each of the pixels of interest are supplied to the calculation unit 205.

The calculation unit 205 generates a plurality of samples of a linear primary expression for calculating the prediction values based on the class taps. For example, a plurality of samples of a linear primary expression shown in Expression (4) are generated for each class code.

yₖ=W₁×xₖ₁+W₂×xₖ₂+ . . . +Wₙ×xₖₙ (where k=1,2, . . . m) (4)

Wᵢ (i=1 to N, n is the number of prediction taps) in Expression (4) is a coefficient used in a product-sum operation of the adaptation processing part 138. xᵢ is a value of a pixel constituting a prediction tap, and y is a prediction value. It should be noted that k is an index expressing a sample number, or the like, and for example, m samples are generated.

The calculation unit 205 computes the coefficient Wᵢ that minimizes an error in Expression (4). First, an error eₖ of each sample in Expression (4) is defined so as to be expressed by Expression (5).

eₖ=yₖ−{W₁×xₖ₁+W₂×xₖ₂+ . . . +Wₙ×xₖₙ} (where k=1,2, . . . m) (5)

In addition, as shown in, for example, Expressions (6) and (7), the coefficient Wᵢ that minimizes an error using a least-square method is computed.

$${e}^{2} = {\sum }_{k = 1}^{m} {e}_{k}^{2} \qquad ( 6 )$$

$$\frac{\partial {e}^{2}}{\partial {W}_{i}} = {\sum }_{k = 1}^{m} 2 ( \frac{\partial {e}_{k}}{\partial {W}_{i}} ) {e}_{k} = {\sum }_{k = 1}^{m} 2 \times {k}_{i} \cdot {e}_{k} \qquad ( 7 )$$

In other words, the square of e is subject to partial differentiation using the coefficient Wᵢ (i=0 to n) as in Expression (7) so as to minimize the square of e of Expression (6), and the coefficient Wᵢ is obtained so that the partial differentiation value becomes 0 for each value of i.

Here, for example, Xⱼᵢ and Yⱼ are defined as shown in Expressions (8) and (9).

$$\begin{matrix}{X}_{ji} = {\sum }_{p = 1}^{m} {x}_{pi} \times {x}_{pj} & ( 8 ) \\ {Y}_{i} = {\sum }_{k = 1}^{m} {x}_{ki} \times {y}_{k} & ( 9 )\end{matrix}$$

Expression (10) is derived from Expressions (4), (8), and (9).

$$( \begin{matrix}{x}_{11} & {x}_{12} & … & {x}_{1 n} \\ {x}_{21} & {x}_{22} & … & {x}_{2 n} \\ ⋮ & ⋮ & ⋮ & ⋮ \\ {x}_{n 1} & {x}_{n 2} & … & {x}_{nn}\end{matrix} ) ( \begin{matrix}{W}_{1} \\ {W}_{2} \\ ⋮ \\ {W}_{n}\end{matrix} ) = ( \begin{matrix}{Y}_{1} \\ {Y}_{2} \\ ⋮ \\ {Y}_{n}\end{matrix} ) \qquad ( 10 )$$

The coefficient Wᵢ can be obtained by solving Expression (10) using a discharge calculation method (Gauss-Jordan elimination method) or the like.

The coefficient Wᵢ obtained by the calculation unit 205 is stored in the coefficient memory 206 in association with a class code decided by the class classification unit 204. Accordingly, as the coefficient is learned by the learning device 200, data stored in the coefficient memory 206 is stored in the coefficient data storage unit 113 of the image quality improvement system 100.

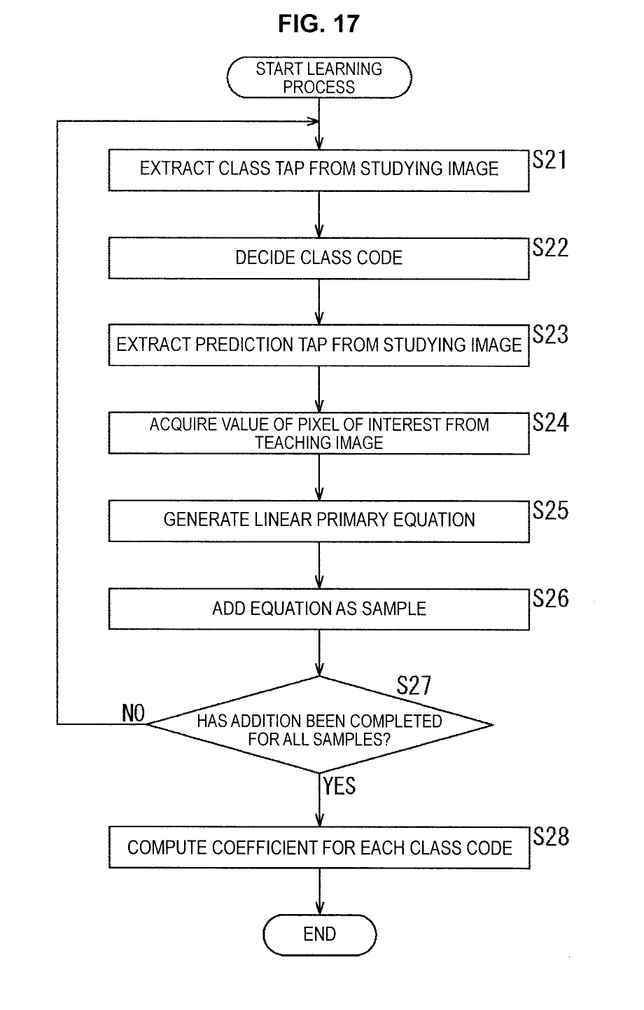

Next, an example of a learning process by the learning device 200 to which the present technology is applied will be described with reference to the flowchart of FIG. 17. When this process is executed, an RGB image with high image quality is received as an input image, and this input image is supplied to the teaching image processing unit 202 as a teaching image. It should be noted that pixel density of the input image is the same as that of a Bayer 2×2 array image. In addition, the thinning processing unit 201 degrades the quality of the input image by, for example, inserting noise therein, and thins color components of pixels according to the pattern of the color filter array. At this moment, the color components of pixels are thinned on the assumption of, for example, the color filters of the imaging element 111. Accordingly, the RGB image is converted into the Bayer 2×2 array image, and the image that has undergone conversion is supplied to the studying image processing unit 203 as a studying image.

In Step S21, the studying image processing unit 203 acquires class taps corresponding to pixels of interest from the studying image. At this moment, the class taps are acquired, for example, as described above referring to FIGS. 7 to 9.

In Step S22, the class classification unit 204 decides class codes based on the class taps acquired in the process of Step S21. At this moment, the class codes are decided using, for example, Expressions (2) and (3) described above.

In Step S23, the studying image processing unit 203 acquires prediction taps corresponding to the pixels of interest from the studying image. At this moment, the prediction taps are acquired, for example, as described above referring to FIGS. 11, 12, 15A, 15B, and 15C.

In Step S24, the teaching image processing unit 202 acquires pixels corresponding to the pixels of interest set in the studying image processing unit 203 from the teaching image. At this moment, the values of the acquired pixels are supplied to the calculation unit 205 as prediction values.

In Step S25, the calculation unit 205 generates a linear primary expression for calculating the prediction values based on the prediction taps acquired in the process of Step S23. For example, the linear primary expression shown in Expression (4) is generated.

In Step S26, the linear primary expression generated in the process of Step S25 is added to each class code.

It should be noted that the studying image processing unit 203 sets each of a plurality of pixels constituting the studying image as pixels of interest in order, and the class codes, the prediction taps, and the prediction values of the pixels of interest are supplied to the calculation unit 205. Accordingly, the calculation unit 205 generates a plurality of samples of the linear primary expression described above.

In Step S27, it is determined whether or not addition of all samples has been completed. When it is determined that addition of all samples has not yet been completed, the process returns to Step S21, and the process of Step S21 and the following processes are repeated.

On the other hand, when it is determined that addition of all samples has been completed in Step S27, the process proceeds to Step S28.

In Step S28, the calculation unit 205 computes coefficients for each class code. At this moment, coefficients W₁, W₂, . . . , Wₘ multiplied by the prediction taps are computed for each class code in the calculation described above, for example, referring to Expressions (5) to (10). In other words, m coefficients are computed for each class code and stored in the coefficient memory 206 in association with corresponding class codes.

In this manner, a learning process is executed.

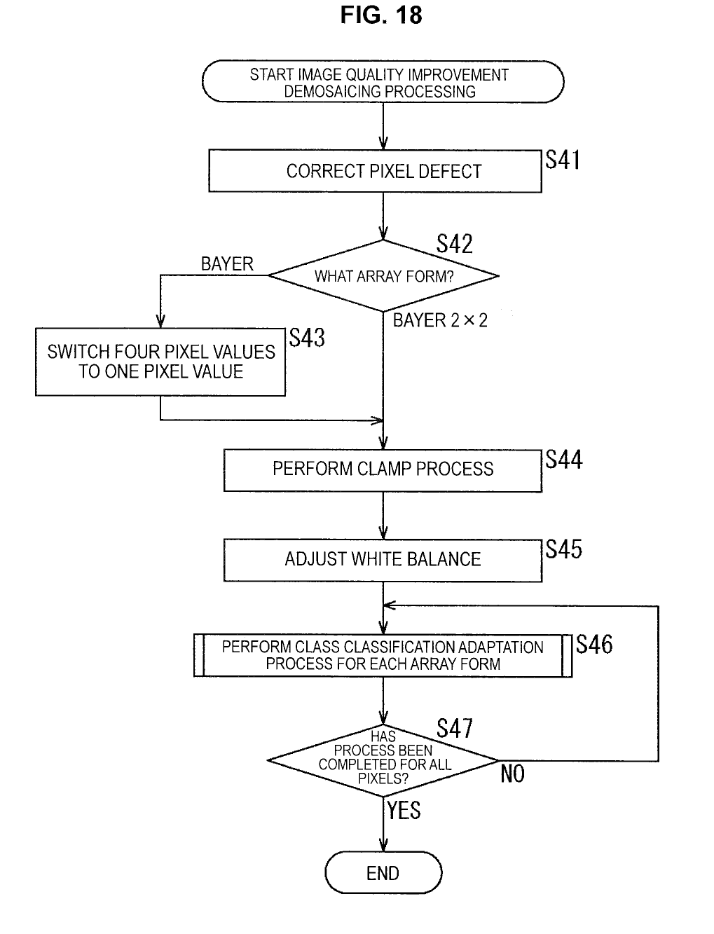

Next, an example of an image quality improving demosaicing process by the image quality improvement system 100 to which the present technology is applied will be described with reference to the flowchart of FIG. 18. This process is executed when, for example, an image is captured by the imaging element 111. It should be noted that, prior to this process, the learning process described above referring to FIG. 17 is executed, and it is assumed that data stored in the coefficient memory 206 is stored in the coefficient data storage unit 113 of the image quality improvement system 100.

In Step S41, the pixel defect correction part 131 corrects a pixel defect. At this moment, the pixel defect correction part 131 detects, for example, a defective pixel (a pixel that does not react to incident light for any reason, or a pixel that accumulates electric charges at all times) among pixels of the imaging element 111, and corrects an output value of the defective pixel by interpolating peripheral normal pixels into the defective pixel so that the normal pixels are not affected by the defective pixel.

In Step S42, the pixel addition processing part 132 determines an array form. At this moment, for example, an operation mode of the image quality improvement system 100 is specified, and an array form is specified according to the operation mode. Here, the operation mode is, for example, a moving image mode, or a still image mode, and specified based on an operation of an apparatus in which the image quality improvement system 100 is installed.

It should be noted that, here, the imaging element 111 is assumed to output data of a Bayer 2×2 array image at all times, and in the moving image mode in which a high-speed process is carried out, the Bayer 2×2 array image output from the imaging element 111 is assumed to be converted into a Bayer array image.

In Step S42, when the array form is determined to be a Bayer array (when the operation mode is the moving image mode), the process proceeds to Step S43.

In Step S43, the pixel addition processing part 132 switches, for example, four pixel values to one pixel value for each color component of R, G, and B of the Bayer 2×2 array image so as to convert the image to data of the Bayer array image. At this moment, the pixel addition processing part 132 converts the data of the Bayer 2×2 array image into data of the Bayer array image by switching the four pixel values to the one pixel value using, for example, the average value of the four pixels having the same color, or a representative value selected from the four pixel values based on a predetermined criterion.

On the other hand, in Step S42, when the array form is determined to be a Bayer 2×2 array image (when the operation mode is the still image mode), the process of Step S43 is skipped, and the pixel addition processing part 132 outputs the data of the Bayer 2×2 array image as is.

Herein, the example in which the pixel addition processing part 132 converts an array form according to the operation mode has been described, but an array form may be converted based on other conditions.

In Step S44, the clamp processing part 133 performs a clamp process. In other words, when AD conversion is performed in the imaging element 111, since a signal value is shifted in a positive direction and subjected to the AD conversion in order to prevent a negative value from being cut, the clamping is performed so that the value corresponding to the shift is canceled.

In Step S45, the white balance part 134 adjusts white balance by correcting gains for each color component.

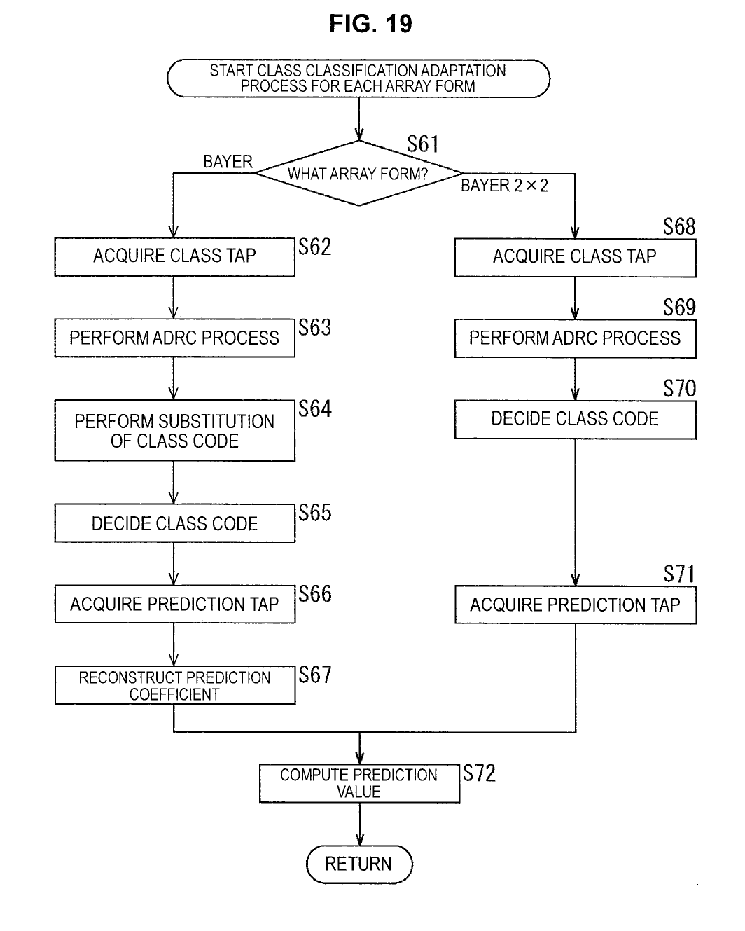

In Step S46, the post-processing unit 122 executes a class classification adaptation process for each array form as will be described referring to the flowchart of FIG. 19.

In Step S47, it is determined whether or not the class classification adaptation process for each array form of Step S46 has been executed for all pixels, and when the process is determined not to have been executed for all pixels, the process of Step S46 is repeated.

On the other hand, when the class classification adaptation process for each array form of Step S46 is determined to have been executed for all pixels in Step S47, the process ends.

In this manner, the image quality improvement demosaicing process is executed.

Next, a detailed example of the class classification adaptation process for each array form of Step S46 shown in FIG. 18 will be described with reference to the flowchart of FIG. 19.

In Step S61, an array form is determined. Here, the array form is determined in the same manner as in the determination in the process of Step S42 of FIG. 18.

In Step S61, when the array form is determined to be a Bayer array, the process proceeds to Step S62.

In Step S62, the class tap acquisition part 135 specifies a pixel of interest that is a pixel to be demosaiced from the Bayer array image that is an input image. In addition, the class tap acquisition part 135 acquires class taps formed by a plurality of pixels having the pixel of interest at the center.

In Step S63, the class classification part 137 performs an ADRC process on the class taps acquired in the process of Step S62.

In Step S64, the class classification part 137 performs substitution of class codes. At this moment, when the class classification part 137 performs class classification through the ADRC based on the class taps shown in FIG. 7, for example, a quantization code is determined regarding four pixels in one circle as one tap (pixel). For example, the quantization code is determined based on the average value or a representative value of the four pixels in one circle. Then, a 9-digit class code of the pixel of interest is decided by arranging quantization codes according to the positions of the taps in order.

Alternatively, when the class taps shown in FIG. 9 are acquired, four quantization codes of the tap of the pixel of interest (taps positioned at the center) among the class taps acquired from the Bayer array image are generated. For example, when a quantization code of the tap of the pixel of interest among the class taps acquired from the Bayer array image is “1,” the code is substituted with “1111.”

In addition, when a quantization code of the tap of the pixel of interest among the class taps acquired from the Bayer array image is “0,” the code is substituted with “0000.”

In Step S65, the class classification part 137 decides class codes based on the result of the process of Step S64.

In Step S66, the prediction tap acquisition part 136 acquires prediction taps formed by the plurality of pixels having the pixel of interest of the input image at the center.

In Step S67, the adaptation processing part 138 reconstructs prediction coefficients. When a product-sum operation is performed based on the prediction taps acquired from the Bayer array image, for example, 52 coefficients are converted into 13 coefficients. For example, the average value (or a representative value) of four coefficients multiplied by four pixels having the same color shown in FIG. 12 is computed, and the one average value (or representative value) is multiplied by each tap of FIG. 11. For example, the average value (or a representative value) of four coefficients each multiplied by four taps of taps 161-1 to 161-4 of the prediction taps of the Bayer 2×2 array image shown in FIG. 13 is computed. One average value (or representative value) obtained in this manner is multiplied by the tap 162 of the prediction taps of the Bayer array image shown in FIG. 14.

On the other hand, in Step S61, when the array form is a Bayer 2×2 array image, the process proceeds to Step S68.

In Step S68, the class tap acquisition part 135 specifies pixels of interests which are pixels to be demosaiced in the Bayer 2×2 array image that is an input image. Then, the class tap acquisition part 135 acquires class taps formed by a plurality of pixels having the pixels of interest at the centers.

In Step S69, the class classification part 137 performs an ADRC process for the class taps acquired in the process of Step S68. It should be noted that, at this moment, quantization codes are determined regarding four pixels in one circle having the same color as one tap in the class taps shown in, for example, FIG. 8. For example, the quantization codes are determined based on the average value or a representative value of four pixels in one circle in FIG. 8.

In Step S70, the class classification part 137 decides class codes based on the result of the process of Step S69.

In Step S71, the prediction tap acquisition part 136 acquires prediction taps formed by the plurality of pixels having the pixels of interest of the input image at the center.

After the process of Step S67 or Step S71, the process proceeds to Step S72.

In Step S72, the adaptation processing part 138 performs a product-sum operation in which coefficients decided according to the class codes of the pixels of interest decided in the process of Step S65 or Step S70 are multiplied by the value of each pixel constituting the prediction taps acquired in the process of Step S66 or Step S71, thereby computing the prediction values of the pixels of interest.

At this moment, the adaptation processing part 138 reads the coefficients stored in the coefficient data storage unit 113, and multiplies the coefficients by the value of each pixel of the prediction taps. In addition, as described above, when the input image is the Bayer array image, the coefficient reconstructed in the process of Step S67 is multiplied by each pixel value of the prediction taps.

In this manner, the class classification adaptation process for each array form is executed.

It should be noted that the image quality improvement system 100 to which the present technology is applied can employ various configurations other than the configuration shown in FIG. 5. For example, the image quality improvement system 100 may be configured using an imaging element and a signal processing circuit mounted on digital cameras, smartphones, and the like, or may be configured by personal computers and servers connected through a network.

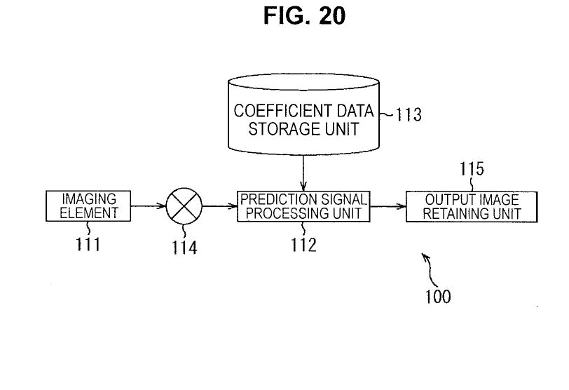

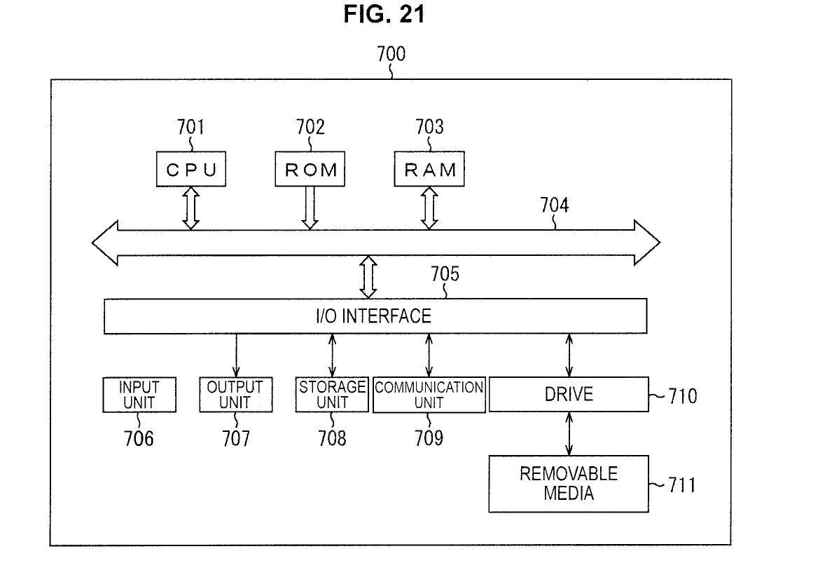

For example, the image quality improvement system 100 may be configured as shown in FIG. 20.

FIG. 20 is a block diagram showing another configuration example of the image quality improvement system 100 to which the present technology is applied.

In the example of FIG. 20, the imaging element 111 and the prediction signal processing unit 112 are connected via a network 114. In addition, in the example of FIG. 20, an output image retaining unit 115 that retains output images is provided in the image quality improvement system 100. Since other constituent elements are the same as those described above referring to FIG. 5, detailed description thereof will be omitted.

Alternatively, the imaging element 111 and the prediction signal processing unit 112 may be connected in an offline manner. Furthermore, the output image retaining unit 115 may be provided in the state in which the imaging element 111 and the prediction signal processing unit 112 are connected using a signal line in the same manner as in the case of FIG. 5.

Alternatively, the entire image quality improvement system 100 shown in FIG. 5 may be configured in, for example, a semiconductor chip. For example, a signal processing circuit formed in a semiconductor chip configured as a solid-state imaging device such as a CMOS imaging element, a CCD imaging element, or the like having a pixel array having a plane over which a plurality of photoelectric conversion elements are arranged may function as the image quality improvement system 100.

The above-described series of processes can be executed by hardware or software. When the above-described series of processes is executed by the software, a program constituting the software is installed from a network of a recording medium to a computer built in dedicated hardware or a general-purpose personal computer 700, for example, which can execute various functions by installing various programs, or the like, as illustrated in FIG. 21.

In FIG. 21, a central processing unit (CPU) 701 executes various processes according to a program stored in a read only memory (ROM) 702 or a program loaded from a storage unit 708 to a random access memory (RAM) 703. In addition, data or the like necessary for executing various processes by the CPU 701 is appropriately stored in the RAM 703.

The CPU 701, the ROM 702, and the RAM 703 are connected to each other via a bus 704. In addition, this bus 704 is also connected to an input/output (I/O) interface 705.

An input unit 706 including a keyboard, a mouse or the like, an output unit 707 including a display such as a liquid crystal display (LCD), a speaker or the like, a storage unit 708 including a hard disk or the like, and a communication unit 709 including a modem, a network interface card such as a local area network (LAN) card, or the like are connected to the I/O interface 705. The communication unit 709 performs a communication process through a network such as the Internet.

If necessary, a drive 710 is connected to the I/O interface 705, removable media 711 such as a magnetic disk, an optical disc, a magneto-optical disc or a semiconductor memory are appropriately mounted, and a computer program read therefrom is installed in the storage unit 708, if necessary.

If the above-described series of processes is executed by software, a program constituting the software is installed from a network such as the Internet or recording media including the removable media 711 and the like.

This recording medium includes, for example, as illustrated in FIG. 21, the removable media 711 including a magnetic disk (including a floppy disk (registered trademark), an optical disc (including a compact disc-read only memory (CD-ROM) or a digital versatile disc (DVD)), a magneto-optical disc (mini disc (MD) (registered trademark)), a semiconductor memory, or the like recording a program distributed to be delivered to a user, separately from a device body. Also, the recording medium includes the ROM 702 recording a program to be delivered to a user in a state in which it is built in the device body in advance, or a hard disk included in the storage unit 708.

The series of processes described in this specification includes processes to be executed in time series in the described order and processes to be executed in parallel or individually, not necessarily in time series.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)
An image processing device including:

a prediction tap acquisition unit that acquires, as prediction taps, values of a plurality of pixels decided according to a pixel of interest from a plurality of input images which are formed by pixels each having a single color component and have different array forms of the pixels;

a coefficient data storage unit that stores data of coefficients multiplied by the respective acquired prediction taps; and

a prediction calculation unit that computes, through calculation using the prediction taps and the coefficients, a value of the pixel of interest in an output image formed by pixels having a plurality of color components, which is an image obtained by demosaicing the input images,

wherein the prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.

(2)
The image processing device according to (1),

wherein each of the input images is a Bayer array image formed by pixels each having a single color component of each color of red, green, and blue, or a Bayer 2×2 array image obtained by dividing each pixel of the Bayer array image into pixels having a same color in two rows and two columns, and

wherein the output image is an RGB image formed by pixels having three color components of red, green, and blue.

(3)
The image processing device according to (2), wherein, when the input image is the Bayer 2×2 array image, the prediction tap acquisition unit acquires a same prediction tap corresponding to pixels of interest at four adjacent positions.
(4)
The image processing device according to (2) or (3), wherein, when the input image is the Bayer array image, the prediction calculation unit computes an average value or a representative value of the coefficients multiplied by four taps in prediction taps of the Bayer 2×2 array image, and computes the value of the pixel of interest in the output image by multiplying the computed average value or representative value by prediction taps of the Bayer array image.
(5)
The image processing device according to (2) or (3), further including:

a class tap acquisition unit that acquires values of a plurality of pixels decided according to the pixel of interest from the input images as class taps; and

a class classification unit that classifies the pixel of interest into a predetermined class.

(6)
The image processing device according to (5), wherein, when the input image is the Bayer 2×2 array image, the class tap acquisition unit acquires class taps obtained by dividing each pixel constituting class taps of the Bayer array image into pixels having a same color in two rows and two columns.
(7)
The image processing device according to (6), wherein, when the input image is the Bayer 2×2 array image, the class classification unit computes an average value or a representative value of four pixels having a same color constituting the class taps, decides class codes having a same number of digits as a class code when the input image is the Bayer array image by performing an ADRC process on the computed average value or representative value, and performs class-classification on the pixel of interest.
(8)
The image processing device according to (6) or (7), wherein, when the input image is the Bayer array image, the class classification unit decides a class code having a same number of digits as class codes when the input image is the Bayer 2×2 array image by interpolating some quantization codes obtained by performing an ADRC process on values of pixels constituting the class taps, and performs class-classification on the pixel of interest.
(9)
The image processing device according to any one of (2) to (8), wherein data of coefficients stored in the coefficient data storage unit is set to be data of coefficients computed by learning with an RGB image having same pixel density as the Bayer 2×2 array image as a teaching image and a Bayer 2×2 array image generated by thinning color components of each pixel of the RGB image as a studying image.
(10)
The image processing device according to any one of (1) to (9), further including:

an input image conversion unit that converts an image in a predetermined array form into an image in another array form according to an operation mode and supplies the image as an input image.

(11)
An image processing method including:

acquiring, as prediction taps, values of a plurality of pixels decided according to a pixel of interest from a plurality of input images which are formed by pixels each having a single color component and have different array forms of the pixels by a prediction tap acquisition unit; and

computing a value of the pixel of interest in an output image formed by pixels having a plurality of color components, which is an image obtained by demosaicing the input images through calculation using the prediction taps and coefficients stored in a coefficient data storage unit,

wherein, using coefficients multiplied by respective prediction taps acquired from a first input image with predetermined pixel density, the value of the pixel of interest in an output image obtained by demosaicing a second input image in a different array form of the pixels with lower pixel density lower than the first input image is computed.

(12)
A program that instructs a computer to function as:

an image processing device including
a prediction tap acquisition unit that acquires, as prediction taps, values of a plurality of pixels decided according to a pixel of interest from a plurality of input images which are formed by pixels each having a single color component and have different array forms of the pixels;
a coefficient data storage unit that stores data of coefficients multiplied by the respective acquired prediction taps; and
a prediction calculation unit that computes, through calculation using the prediction taps and the coefficients, a value of the pixel of interest in an output image formed by pixels having a plurality of color components, which is an image obtained by demosaicing the input images,
wherein the prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.
   (13)
   A solid-state imaging device including:

a pixel array having a plane over which a plurality of photoelectric conversion elements are arranged;

a prediction tap acquisition unit that acquires, as prediction taps, values of a plurality of pixels decided according to a pixel of interest from a plurality of input images which are generated based on a signal output from the pixel array, are formed by pixels each having a single color component, and have different array forms of the pixels;

a coefficient data storage unit that stores data of coefficients multiplied by the respective acquired prediction taps; and

a prediction calculation unit that computes, through calculation using the prediction taps and the coefficients, a value of the pixel of interest in an output image formed by pixels having a plurality of color components, which is an image obtained by demosaicing the input images,

wherein the prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.

The present disclosure contains subject matter related to that disclosed in Japanese Priority Patent Application JP 2012-183838 filed in the Japan Patent Office on Aug. 23, 2012, the entire content of which is hereby incorporated by reference.

What is claimed is:

1. An image processing device comprising:
a prediction tap acquisition unit that acquires, as prediction taps, values of a plurality of pixels decided according to a pixel of interest from a plurality of input images which are formed by pixels each having a single color component and have different array forms of the pixels;
a coefficient data storage unit that stores data of coefficients multiplied by the respective acquired prediction taps; and
a prediction calculation unit that computes, through calculation using the prediction taps and the coefficients, a value of the pixel of interest in an output image formed by pixels having a plurality of color components, which is an image obtained by demosaicing the input images,
wherein the prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.

2. The image processing device according to claim 1,
wherein each of the input images is a Bayer array image formed by pixels each having a single color component of each color of red, green, and blue, or a Bayer 2×2 array image obtained by dividing each pixel of the Bayer array image into pixels having a same color in two rows and two columns, and
wherein the output image is an RGB image formed by pixels having three color components of red, green, and blue.

3. The image processing device according to claim 2, wherein, when the input image is the Bayer 2×2 array image, the prediction tap acquisition unit acquires a same prediction tap corresponding to pixels of interest at four adjacent positions.

4. The image processing device according to claim 2, wherein, when the input image is the Bayer array image, the prediction calculation unit computes an average value or a representative value of the coefficients multiplied by four taps in prediction taps of the Bayer 2×2 array image, and computes the value of the pixel of interest in the output image by multiplying the computed average value or representative value by prediction taps of the Bayer array image.

5. The image processing device according to claim 2, further comprising:
a class tap acquisition unit that acquires values of a plurality of pixels decided according to the pixel of interest from the input images as class taps; and
a class classification unit that classifies the pixel of interest into a predetermined class.

6. The image processing device according to claim 5, wherein, when the input image is the Bayer 2×2 array image, the class tap acquisition unit acquires class taps obtained by dividing each pixel constituting class taps of the Bayer array image into pixels having a same color in two rows and two columns.

7. The image processing device according to claim 6, wherein, when the input image is the Bayer 2×2 array image, the class classification unit computes an average value or a representative value of four pixels having a same color constituting the class taps, decides class codes having a same number of digits as a class code when the input image is the Bayer array image by performing an ADRC process on the computed average value or representative value, and performs class-classification on the pixel of interest.

8. The image processing device according to claim 6, wherein, when the input image is the Bayer array image, the class classification unit decides a class code having a same number of digits as class codes when the input image is the Bayer 2×2 array image by interpolating some quantization codes obtained by performing an ADRC process on values of pixels constituting the class taps, and performs class-classification on the pixel of interest.

9. The image processing device according to claim 2, wherein data of coefficients stored in the coefficient data storage unit is set to be data of coefficients computed by learning with an RGB image having same pixel density as the Bayer 2×2 array image as a teaching image and a Bayer 2×2 array image generated by thinning color components of each pixel of the RGB image as a studying image.

10. The image processing device according to claim 1, further comprising:
an input image conversion unit that converts an image in a predetermined array form into an image in another array form according to an operation mode and supplies the image as an input image.

11. An image processing method comprising:
acquiring, as prediction taps, values of a plurality of pixels decided according to a pixel of interest from a plurality of input images which are formed by pixels each having a single color component and have different array forms of the pixels by a prediction tap acquisition unit; and
computing a value of the pixel of interest in an output image formed by pixels having a plurality of color components, which is an image obtained by demosaicing the input images through calculation using the prediction taps and coefficients stored in a coefficient data storage unit,
wherein, using coefficients multiplied by respective prediction taps acquired from a first input image with predetermined pixel density, the value of the pixel of interest in an output image obtained by demosaicing a second input image in a different array form of the pixels with lower pixel density lower than the first input image is computed.

12. A program that instructs a computer to function as:
an image processing device including
a prediction tap acquisition unit that acquires, as prediction taps, values of a plurality of pixels decided according to a pixel of interest from a plurality of input images which are formed by pixels each having a single color component and have different array forms of the pixels;
a coefficient data storage unit that stores data of coefficients multiplied by the respective acquired prediction taps; and
a prediction calculation unit that computes, through calculation using the prediction taps and the coefficients, a value of the pixel of interest in an output image formed by pixels having a plurality of color components, which is an image obtained by demosaicing the input images,
wherein the prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.

13. A solid-state imaging device comprising:
a pixel array having a plane over which a plurality of photoelectric conversion elements are arranged;
a prediction tap acquisition unit that acquires, as prediction taps, values of a plurality of pixels decided according to a pixel of interest from a plurality of input images which are generated based on a signal output from the pixel array, are formed by pixels each having a single color component, and have different array forms of the pixels;
a coefficient data storage unit that stores data of coefficients multiplied by the respective acquired prediction taps; and
a prediction calculation unit that computes, through calculation using the prediction taps and the coefficients, a value of the pixel of interest in an output image formed by pixels having a plurality of color components, which is an image obtained by demosaicing the input images,
wherein the prediction calculation unit computes, using coefficients multiplied by respective prediction taps acquired from a first input image with predetermined pixel density, the value of the pixel of interest in an output image obtained by demosaicing a second input image having a different array form of the pixels with lower pixel density than the first input image.
